(19) United States
(12) Patent Application Publication
(10) Pub. No.: US 2020/0396804 A1
(43) Pub. Date: Dec. 17, 2020

(54) ELECTROMAGNETIC INDUCTION HEATING DEVICE

(71) Applicant: Tadashi KUBONO, Shizuoka (JP)

(72) Inventors: Tadashi KUBONO, Shizuoka (JP); Seiji KAWAMOTO, Shizuoka (JP)

(21) Appl. No.: 16/613,416

(22) PCT Filed: May 15, 2019
(86) PCT No.: PCT/JP2019/019344

§ 371 Date: Nov. 14, 2019

(30) Foreign Application Priority Data
May 18, 2018 (JP) 2018-096357

(51) Int. Cl. H05B 6/10

(52) U.S. Cl. CPC H05B 6/109

(57) ABSTRACT

An electromagnetic induction heating device includes a rotator in which a plurality of magnets is arranged in a manner that the same poles are positioned on a side of an object to be heated, and a rotation drive part for rotating the rotator, and heats the object to be heated by an induction current which is generated by rotating the rotator, wherein magnets adjacent in a direction in which the rotator is rotated are arranged with an interval of 10 mm or more. Thereby, heating efficiency by electromagnetic induction is improved, and the object to be heated such as an aluminium material or the like can be brought to a predetermined temperature in a short time.

### BACKGROUND OF THE INVENTION

### Technical Field

The present invention relates to an electromagnetic induction heating device which can substitute for a heating device that uses a gas flame, an electric heater or the like and heats an object to be heated such as an aluminium material or the like by generating an induction current using magnets.

### Related Art

Aluminium is excellent in lightness, workability, and recyclability. Therefore, a usage amount of aluminium which is used as a material for automobiles, buildings, household electric/electronic appliances or the like is increasing. When an aluminium material is processed, a heat source used for melting and heat treatments or the like is mainly gas flame, electric heat or the like. For example, when the aluminium material is processed, the aluminium material is put into a gas furnace or an electric furnace and is heated from the surroundings by the flame or the electric heat. A heating method using flame or electric heat as a heat source has a problem that economic efficiency of energy consumption is low and further has a problem that a generation amount of carbon dioxide is great. Therefore, the heating method using flame or electric heat as the heat source is not preferable from the viewpoint of environmental protection.

As a method which heats using a heat source other than gas flame or electric heat, there is electromagnetic induction heating in which an object to be heated is heated by generating an induction current using magnets. The electromagnetic induction heating does not use fuel such as gas or oil, and thus no carbon dioxide with combustion is generated. Therefore, the electromagnetic induction heating is a method more friendly to the environment than the conventional heating method. In addition, the electromagnetic induction heating releases less heat to the surroundings, and thus a heating furnace like the heating method using flame or electric heat is not necessary. Therefore, using the electromagnetic induction heating in the processing of the aluminum material can contribute to space saving in a factory. In this way, the electromagnetic induction heating is more excellent than the heating method using flame or electric heat in terms of low environmental impact and being useful for space saving.

As a device using electromagnetic induction heating, a heater device is recited which includes a conductive member and magnets arranged close to the conductive member, and heats the conductive member by the magnets applying a periodically changing magnetic field to the conductive member (patent literature 1).

### LITERATURE OF RELATED ART

### Patent Literature

Patent literature 1: Japanese Publication of International Paten Application No. 2004-537147

### SUMMARY

### Problems to be Solved

In patent literature 1, a heater device in which a plurality of magnets is symmetrically or asymmetrically arranged in a peripheral portion of a frame and a heater device in which a plurality of magnets is arranged along an arc near a center of a frame and an arc in a peripheral portion are recited. However, a configuration for efficiently heating the member to be heated is not recited.

A subject of the present invention is to provide an electromagnetic induction heating device with good heating efficiency which can effectively heat an object to be heated such as an aluminum material.

### Means to Solve Problems

The inventors found that arrangement of magnets greatly affects the heating efficiency of the electromagnetic induction heating device and accomplished the present invention. The present invention provided to solve the above problems is as follows.

The electromagnetic induction heating device of the present invention includes a rotator in which a plurality of magnets is arranged in a manner that the same poles are positioned on a side of an object to be heated and a rotation drive part for rotating the rotator, and heats the object to be heated by an induction current which is generated by rotating the rotator, wherein an interval between magnets adjacent in a direction in which the rotator is rotated is 10 mm or more.

The interval may be 20 mm or more and 45 mm or less. In addition, the plurality of magnets may be arranged concentrically taking a rotation center of the rotator as a center.

The plurality of magnets may be arranged concentrically taking a rotation center of the rotator as a center, the plurality of magnets arranged along each circle may be arranged at equal intervals, and the interval may be 20 mm or more and 45 mm or less.

The concentric circles may be arranged at equal intervals, and differences between diameters of the adjacent concentric circles may be 40 mm or more and 60 mm or less.

The plurality of magnets may have a cylindrical shape in which a diameter is 5 mm or more and 25 mm or less and a height is 10 mm or more and 40 mm or less.

The plurality of magnets may have a height 0.5 time or more and 2 times or less of the diameter.

A magnetic flux density of the magnets may be 400 mT or more and 600 mT or less.

The plurality of magnets may be mounted to the rotator via a height adjustment part.

### Effect

Compared with a case in which many magnets are arranged at a narrow interval, the electromagnetic induction heating device of the present invention can more efficiently heat the object to be heated by arranging the magnets in a manner that the interval of the magnets adjacent in the rotation direction of the rotator is 10 mm or more. Therefore, the electromagnetic induction heating device with good heating efficiency can be provided.

### BRIEF DESCRIPTION OF THE DRAWINGS

FIG. 1 is a front view schematically showing a schematic configuration of an electromagnetic induction heating device according to an embodiment of the present invention.

FIG. 2 is a view along arrows A1-A1 in FIG. 1 and is a plane view in which a rotator is viewed from a side of a magnet surface where magnets are arranged.

FIG. 3 is a perspective view showing a shape of the magnets.

FIG. 4 is a front view of a rotator and an object to be heated.

FIG. 5 is a plane view which illustrates arrangement of an object to be heated in an implementation example 1, and in which the rotator is viewed from a side of a magnet surface.

FIG. 6 is a plane view schematically showing arrangement of magnets in implementation examples 6 to 9.

FIG. 7 is a cross-section view for illustrating a measurement method of magnetic flux densities in implementation examples 6 to 9.

FIG. 8 is a graph showing measurement results of implementation examples 6 and 7.

FIG. 9 is a graph showing measurement results of implementation examples 8 and 9.

### DESCRIPTION OF THE EMBODIMENTS

Embodiments of the present invention are described below with reference to the drawings.

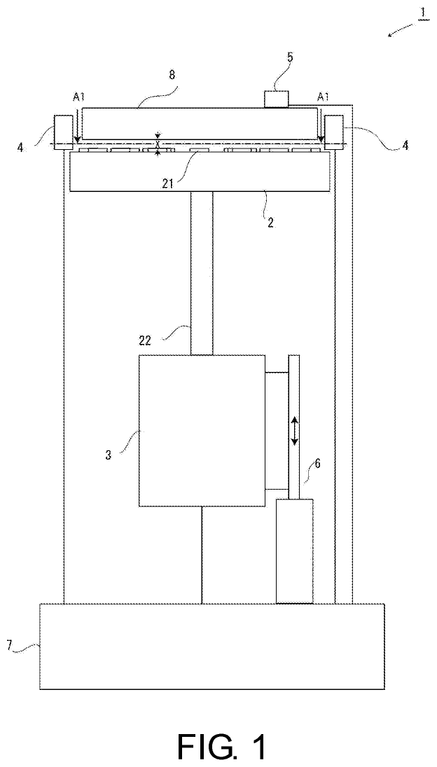

FIG. 1 is a front view schematically showing a schematic configuration of an electromagnetic induction heating device 1 according to a first embodiment of the present invention. As shown in the diagram, the electromagnetic induction heating device 1 of the embodiment includes a rotator 2, a rotation drive motor 3, a distance measurement part 4, a temperature measurement part 5, a motor for movement 6, and a control part 7.

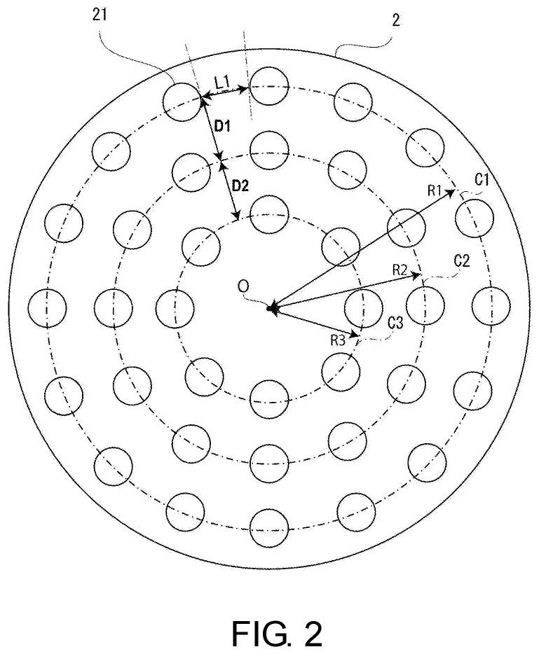

FIG. 2 is a view along arrows A1-A1 in FIG. 1 and is a plane view in which the rotator 2 is viewed from a side of a surface where magnets 21 are arranged in the rotator 2 (hereinafter, also called a “magnet surface”). As shown in FIG. 2, the rotator 2 has a plurality of magnets 21 which is arranged concentrically (annularly) on one surface of the disk.

In FIG. 2, a form is shown in which the plurality of magnet 21 is arranged around a rotation center O of the rotator 2 along each of circles C1, C2 and C3 respectively having a radius R1, a radius R2 and a radius R3 and indicated by dashed-dotted lines. Moreover, the number and arrangement of the magnets shown in the diagram are merely examples for describing embodiments of the present invention and can be changed corresponding to sizes of the rotator 2 and the magnets 21.

The plurality of magnets 21 arranged along the circle C1, the circle C2 and the circle C3 indicated by the dashed-dotted lines in FIG. 2 is arranged in a manner that an interval L1 with magnets 21 adjacent in a direction in which the rotator 2 is rotated is a predetermined distance. Here, “the interval L1” means a distance between the closest parts of the adjacent magnets 21 which are arranged along each of the circle C1, the circle C2 and the circle C3. In a case of the cylindrical magnet 21 shown in FIG. 2, the interval L1 is a distance obtained by subtracting radii of the two magnets 21 from the distance (a pitch) between centers of circles of the adjacent magnets 21. For example, when the distance between the centers is 50 mm and the radii of the circles of the adjacent magnets 21 are 10 mm, the interval L1 is 30 mm obtained by subtracting a total of 20 mm of the radii of the two magnets 21 from the distance of 50 mm between the centers.

As shown in FIG. 2, in the electromagnetic induction heating device 1 of the embodiment, the plurality of magnets 21 arranged along the circle C1, the circle C2 and the circle C3 (hereinafter, referred to as the circles C when describing aspects common to the circle C1, the circle C2 and the circle C3) is arranged at a predetermined interval L1 in the rotation direction. By arranging at the interval L1 in this way, heating efficiency of an object to be heated 8 can be improved compared with a case in which a plurality of magnets 21 is arranged in contact with each other. In the present invention, arranging the plurality of magnets 21 along the circles C means that the magnets 21 shown in FIG. 2 are positioned in each circle C. Each magnet 21 is preferably arranged in a manner that the center of each magnet 21 is positioned on the circle C indicated by the dashed-dotted line.

From the viewpoint of improving the heating efficiency of the object to be heated 8, the interval L1 between the adjacent magnets 21 is preferably 10 mm or more, more preferably 20 mm or more, and further preferably 30 mm or more. In addition, from the same viewpoint, the interval L1 between the magnets 21 is preferably 50 mm or less, more preferably 45 mm or less, and further preferably 40 mm or less. By setting the interval L1 within the above ranges, a magnetic flux density near the magnet surface of the rotator 2 on which the plurality of magnets 21 is arranged increases. Therefore, an induction current generated in the object to be heated 8 along with the rotation of the rotator 2 can effectively heat the object to be heated 8.

Arranging the adjacent magnets 21 on the circles C at the interval L1 means arranging in a manner that the distance with the adjacent magnets 21 is within the range of the interval L1. The interval L1 is not one specified distance, but means a distance range. Therefore, the present invention is not limited to a configuration in which the intervals between the adjacent magnets 21 are all equally arranged to be the same distance, and even if the distances between the adjacent magnets 21 are different, it is sufficient that each distance is within the range of the interval L1. However, from the viewpoint of improving the heating efficiency of the object to be heated 8, a configuration is preferable in which the plurality of magnets 21 arranged along each of the circles C is arranged at equal intervals.

The circle C1, the circle C2 and the circle C3 which are concentrically arranged may be large enough to arrange the magnets 21 side by side. For example, when the magnets 21 have a cylindrical shape with a cross-sectional diameter of 20 mm, differences D1 (=R1−R2) and D2 (=R3−R2) between diameters of adjacent concentric circles are preferably 40 mm or more and 60 mm or less, and more preferably 45 mm or more and 55 mm or less. A configuration may be employed in which the circle C1, the circle C2 and the circle C3 which are concentrically arranged are respectively arranged at equal intervals (D1=D2).

The rotator 2 is connected to the rotation drive motor 3 via a rotation shaft 22 at a position of a center of the concentric circles of the magnets 21 on a surface opposite the magnet surface (see FIG. 1). The rotator 2 is rotated by the rotation drive motor 3 and an induction current is generated in the object to be heated 8 for heating. As a means for connecting the rotator 2 and the rotation drive motor 3, a known means such as a chain, a belt or the like other than the rotation shaft 22 may be used.

Ferrite magnets, rare earth magnets such as samarium-cobalt magnets (Sm—Co magnets), neodymium magnets (Nd—Fe—B magnets) and the like, alnico magnets (Al—Ni—Co magnets), and the like can be used as the magnets 21. From the viewpoint of efficiently heating the object to be heated 8, magnets such as rare earth magnets or the like which have a strong magnetic force are preferable.

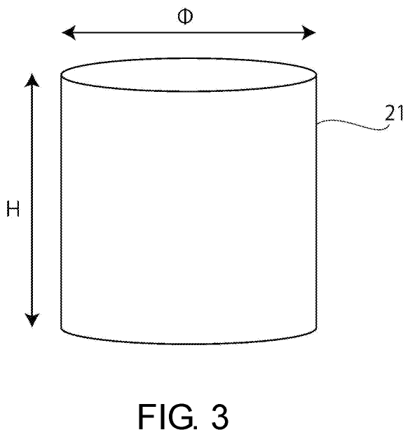

FIG. 3 is a perspective view showing a shape of the magnets 21. As shown in the diagram, the shape of the magnets 21 is preferably a cylindrical shape. The cylindrical magnets 21 can be, for example, magnets having a diameter ϕ of 5 mm or more and 25 mm or less and a height H of 5 mm or more and 30 mm or less. When the cylindrical magnets 21 are used, in order to avoid effects of magnet heating, the height H is preferably 0.5 time or more and 2.0 times or less of the diameter ϕ (0.5ϕ≤H≤2.0ϕ), more preferably 0.7 time or more and 1.5 times or less of the diameter ϕ (0.7ϕ≤H≤1.5ϕ), and further preferably 0.8 time or more and 1.2 times or less of the diameter ϕ (0.8ϕ≤H≤1.2ϕ).

From the viewpoint of improving the heating efficiency of the object to be heated 8, a magnetic flux density on surfaces of the magnets 21 is preferably 350 mT or more, more preferably 400 mT or more, and further preferably 450 mT or more. An upper limit of the magnetic flux density is not particularly limited and is, for example, 600 mT or less.

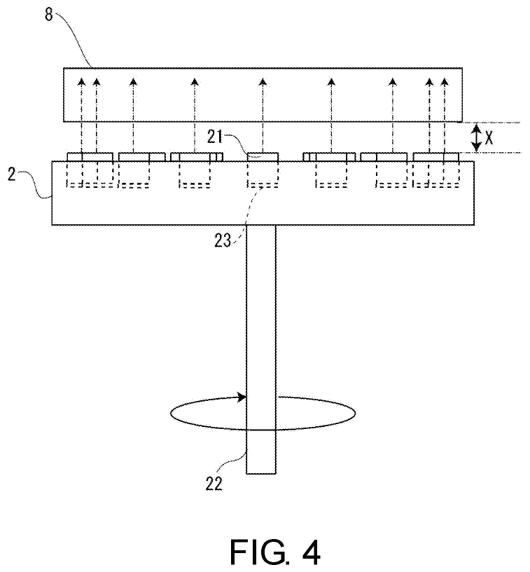

FIG. 4 is a side view of the rotator and the object to be heated. In the diagram, regarding the magnets 21 arranged on the outermost circle C1 (see FIG. 2), an outer shape inside the rotator 2 is indicated by a broken line. FIG. 4 shows an example in which N poles of all the magnets 21 are positioned on the side of the object to be heated 8, but a configuration in which S poles of all the magnets 21 are positioned on the side of the object to be heated 8 may also be employed. By arranging all the magnets 21 in a manner that the same poles are positioned on the side of the object to be heated 8, magnetic fluxes become parallel as shown by dotted arrows in FIG. 4, and magnetic force lines reach positions far from the rotator 2. Therefore, by rotating the rotator 2, a large eddy-like induction current (hereinafter, also called an “eddy current”) can be generated in a wide range of the object to be heated 8, and thus the object to be heated 8 can be effectively heated.

As shown in FIG. 4, the magnets 21 are mounted to the rotator 2 via a height adjustment part 23. Errors of the height H (see FIG. 3) of the magnets 21 are adjusted by the height adjustment part 23, and thereby the heights of the magnets 21 on the magnet surface can be made uniform. Thereby, a distance X between the magnets 21 and the object to be heated 8 is made equal, and the object to be heated 8 can be effectively heated.

In the embodiment, a configuration in which the rotator 2 is rotated in order to generate an induction current in the object to be heated 8 is shown. However, a configuration in which the rotator 2 is fixed and the object to be heated 8 is rotated to generate the induction current may also be employed. However, an effect that the magnets 21 are cooled by air is obtained by rotating the rotator 2, and thus when rare earth magnets with a relatively low Curie point are used as the magnets 21, a configuration of rotating the rotator 2 is preferable. The electromagnetic induction heating device 1 may cool the magnets 21 using a cooling part such as a cooling fan or the like.

The rotation drive motor 3 (see FIG. 1) drives and rotates the rotator 2 via the rotation shaft 22, and is configured in a manner that a rotation torque, a rotation number and the like can be changed by the control part 7 described later.

The distance measurement part 4 measure the distance X between an end on the object to be heated 8 side of the magnet 21 of the rotator 2 and the object to be heated 8. The distance measurement part 4 may be, for example, a part for detecting change in capacitance between the magnets 21 of the rotator 2 and the object to be heated 8, or change in laser light passing through a gap between the magnets 21 of the rotator 2 and the object to be heated 8.

FIG. 1 shows an example in which two distance measurement parts 4 are included, but the distance measurement part 4 may also be one or three or more. From the viewpoint of measurement precision, preferably, the distance X is measured using a plurality of the distance measurement parts 4.

The temperature measurement part 5 measures a temperature of the object to be heated 8 and outputs a result to the control part 7. A known temperature sensor such as a thermocouple can be used as the temperature measurement part 5. The temperature of the object to be heated 8 may be measured in one place as shown in FIG. 1; however, when it is necessary to measure the temperature for each part of the object to be heated 8, preferably, the temperature of the object to be heated 8 is measured using a plurality of the temperature measurement parts 5.

The motor for movement 6 moves the rotation drive motor 3 in a direction parallel to the rotation shaft 22 and changes the distance X between the rotator 2 and the object to be heated 8. For example, when it is detected by the distance measurement part 4 that the object to be heated 8 is thermally expanded and the distance X is reduced, the rotation drive motor 3 is moved in a direction separated from the object to be heated 8, and the distance X can be maintained in a range where the heating efficiency is good.

In FIG. 1, a configuration is shown in which the motor for movement 6 which moves the rotation drive motor 3 is included in order to change the position of the rotator 2; however, a configuration in which the position of the object to be heated 8 is moved or a configuration in which positions of the rotator 2 and the object to be heated 8 are respectively moved may also be employed.

The control part 7 is electrically connected in a wired or wireless manner to the rotation drive motor 3, the distance measurement part 4, the temperature measurement part 5 and the motor for movement 6 that are described above and controls each of them, and can be configured using, for example, a computer or the like.

The control part 7 controls the rotation drive motor 3 or the motor for movement 6 using the distance X measured by the distance measurement part 4. When it is detected that the object to be heated 8 is expanded and deformed by heating, the rotation drive motor 3 is stopped or the rotator 2 is moved by the motor for movement 6. Thereby, contact between the rotator 2 and the object to be heated 8 can be prevented. For example, when the distance X between the rotator 2 and the object to be heated 8 is so small that there is a risk of contact, the rotator 2 is moved in the direction separated from the object to be heated 8. At this time, if the distance X is maintained in the range where the heating efficiency is good, the heating efficiency can be improved.

The control part 7 can control the rotation drive motor 3 or the motor for movement 6 using the temperature of the object to be heated 8 which is measured by the temperature measurement part 5. For example, before the object to be heated 8 reaches the predetermined temperature, the distance X and the rotation number for a high heating efficiency are maintained, and the distance X and the rotation number are changed as the target temperature is approached, and thereby the temperature of the object to be heated 8 can be precisely controlled. At the time the object to be heated 8 reaches the predetermined temperature, the rotation drive motor 3 may be stopped and the rotator 2 may be moved in the direction separated from the object to be heated 8.

When the electromagnetic induction heating device 1 includes a plurality of the distance measurement parts 4, the control part 7 may control each portion using a maximum value or a minimum value among a plurality of the detected distances X.

The object to be heated 8 is made of a material which generates an eddy current by changing the magnetic field. The object to be heated 8 may be an object made of, for example, an aluminum alloy and the like containing aluminum, specifically, may be an aluminum sash, an aluminum foil or the like. In addition, an object made of a light alloy which is an alloy mainly composed of light metals such as aluminum, magnesium, titanium and the like can also be heated as the object to be heated 8.

In FIG. 1, the electromagnetic induction heating device 1 is arranged at one side of the object to be heated 8; however, a configuration may also be employed in which electromagnetic induction heating devices 1 are arranged respectively at both sides of the object to be heated 8. By using a plurality of electromagnetic induction heating devices 1, time required for the object to be heated 8 to reach the predetermined temperature can be shortened, or the object to be heated 8 can be heated to a higher temperature.

### Implementation Examples

The present invention is more specifically described below by implementation examples, but the present invention is not limited to these examples.

An electromagnetic induction heating device including the following magnets is used to heat the following object to be heated, and thermocouples which are arranged at positions 100 mm and 150 mm from a center of the object to be heated are used to measure the time required from start of the heating until the temperature of the object to be heated reaches 300° C.
Object to be heated (ingot)
   Material: aluminum alloy
   Shape: trapezoidal columnar shape (width 97 mm, length 600 mm)
   Weight: 5.0 kg
   Specific heat: 900 (J/Kg K) (20° C.)
   Thermal conductivity: 204 (W/m K)
Magnets (neodymium magnets)
   Shape: cylinder shape
   Diameter: 20 mm
   Height: 20 mm
   Magnetic flux density: 560-590 mT

### Implementation Example 1

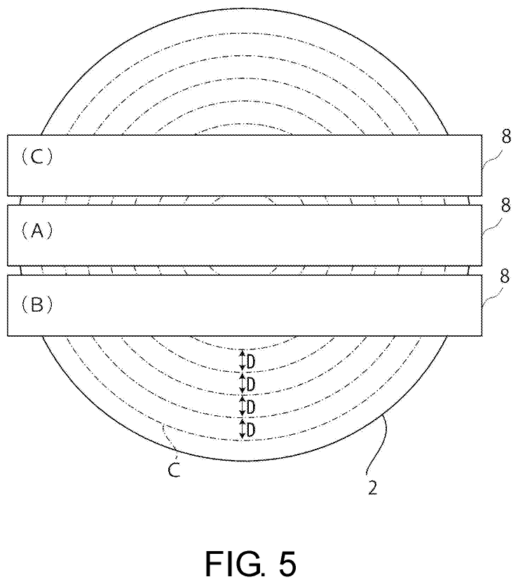

The electromagnetic induction heating device 1 is used which includes the rotator 2 with a diameter of 660 mm in which a plurality of neodymium magnets is equally arranged on the magnet surface (see FIG. 1 and FIG. 2). The distance X from the object to be heated 8 to the magnets 21 of the rotator 2 is set to 0.45 mm. As shown in FIG. 5, one object to be heated 8 is arranged and heated at any of three positions, i.e. (A) a position overlapping the center of the rotator 2, (B) (C) positions shifted from the center of the rotator 2, and temperature change of the object to be heated 8 at each position is measured. Moreover, in FIG. 5, the magnets 21 are omitted and only the concentric circles showing arrangement of the magnets 21 are shown.

On the magnet surface, along eight circles C being concentric circles with diameters of 530 mm, 480 mm, 430 mm, 380 mm, 330 mm, 280 mm, 230 mm and 180 mm, 65, 59, 54, 46, 40, 35, 28 and 22 magnets 21 are respectively arranged in this order at equal intervals along the same circle C.

In the implementation example, the interval L1 between adjacent magnets 21 in the rotation direction is set to 5-6 mm (a distance (a pitch) between centers of the magnets 21 is set to 25-26 mm), and the interval D between adjacent concentric circles is set to 50 mm.

An inverter setting frequency is set to 90 Hz, and the time required for the temperature of the object to be heated to reach 300° C. from the start of the heating is measured.

### Implementation Example 2

An electromagnetic induction heating device 1 is used which is only different from the electromagnetic induction heating device 1 of implementation example 1 in terms of a configuration that the numbers of the magnets 21 which are equally arranged along eight circles being concentric circles arranged at equal intervals on the magnet surface with diameters of 530 mm, 480 mm, 430 mm, 380 mm, 330 mm, 280 mm, 230 mm and 180 mm are 33, 30, 27, 23, 20, 17, 14 and 11.

The same as in implementation example 1, the distance X from the object to be heated 8 to the magnets 21 of the rotator 2 is set to 0.45 mm.

In the implementation example, because the numbers of the magnets 21 arranged in the rotator 2 are approximately half of the numbers in implementation example 1, the interval L1 between adjacent magnets 21 in the rotation direction is set to 30-32 mm (the distance (the pitch) between centers of the magnets 21 is set to 50-52 mm), and the interval D between adjacent concentric circles is set to an equal interval (50 mm).

The same as in implementation example 1, the inverter setting frequency is set to 90 Hz, and the time required for the temperature of the object to be heated to reach 300° C. from the start of the heating is measured.

Measurement results of implementation examples 1 and 2 are shown in table 1.

TABLE 1

| | Implementation | | | Implementation | | |
|---|---|---|---|---|---|---|
| | example 1 | | | example 2 | | |
| Position | (A) | (B) | (C) | (A) | (B) | (C) |
| Reaching | 11 | 5 | 6 | 3 | 2 | 2 |
| time | minutes | minutes | minutes | minutes | minutes | minutes |
| | and 33 | and 16 | and 26 | and 11 | | and 1 |
| | seconds | seconds | seconds | seconds | | second |

It is known from the results shown in table 1 that by reducing the number of the magnets in half, the distance (the pitch) between each magnet increases, and the time for the object to be heated to reach 300° C. can be shortened.

In addition, it is known that by arranging the object to be heated shifted from the rotation center of the rotator 2, the heating efficiency is improved compared with arranging in a manner of overlapping the rotation center of the rotator 2.

It is known from the results shown in table 1 that as the number of the magnets which are arranged at equal intervals along the circles becomes greater, the object to be heated cannot be heated more efficiently, and the heating efficiency of the object to be heated is greatly affected by the distance between the magnets adjacent in the rotation direction of the rotator 2. Thus, in order to examine the effect of the distance between the magnets on the magnetic flux density, the magnetic fields at positions 12 mm away from a surface of each magnet 21 on the side of the object to be heated are measured for implementation example 1 in which 65 neodymium magnets are arranged along the circle with the diameter of 530 mm, and for implementation example 2 in which 33 neodymium magnets are arranged along the same circle. The measurement results are shown in table 2.

TABLE 2

| | Implementation | Implementation |
|---|---|---|
| | example 1 | example 2 |
| Diameter of circle (mm) | 530 | 530 |
| Number of magnets | 65 | 33 |
| Diameter of magnets (mm) | 20 | 20 |
| Distance (mm) | 6 | 30 |
| Pitch (mm) | 26 | 50 |
| Peak value of magnetic flux density | 55-94.2 | 78-109.2 |
| (mT) | | |

As shown in table 2, it is known that the magnetic flux density on the side of the object to be heated is higher in implementation example 2 having a relatively sparse arrangement of the magnets than in implementation example 1 having a relatively dense arrangement of the magnets. From this result, it can be stated that the reason for the improvement of the heating efficiency by arranging a reduced number of the magnets is that the magnetic flux density is increased.

### Implementation Examples 3-5

Except that the inverter setting frequency is changed from 90 Hz to 60-80 Hz, the time required for heating the object to be heated to reach 300° C. is measured in the same way as implementation example 2. Measurement results of implementation examples 1 to 5 are shown in table 3.

TABLE 3

| | Implemen- | Implemen- | Implemen- | Implemen- | Implemen- |
|---|---|---|---|---|---|
| | tation | tation | tation | tation | tation |
| | example 1 | example 2 | example 3 | example 4 | example 5 |
| Position | (B) | (B) | (B) | (B) | (B) |
| Distance | 5-6 | 30-32 | 30-32 | 30-32 | 30-32 |
| (mm) | | | | | |
| Frequency | 90 | 90 | 60 | 70 | 80 |
| (Hz) | | | | | |
| Reaching | 5 minutes | 2 minutes | 3 minutes | 2 minutes | 2 minutes |
| time | and 16 | and 0 | and 14 | and 43 | and 21 |
| | seconds | second | seconds | seconds | seconds |

As shown in implementation examples 2-5, it is known that the heating efficiency of the object to be heated is affected by a rotation speed (a frequency) of the rotator in which the magnets are arranged. However, in implementation example 3 in which the frequency is set to 60 Hz and the distance is set to 30-32 mm, the object to be heated can reach 300° C. in a time about 40% shorter than the time of implementation example 1 in which the frequency is set to 90 Hz and the distance is set to 5-6 mm. From this result, it can be stated that the interval L1 between the magnets 21 adjacent in the rotation direction affects the heating efficiency more greatly than the rotation speed of the rotator.

From the results of implementation examples 1-5, it is known that the magnetic flux density is increased and the heating efficiency is improved by arranging the magnets in a manner that the interval between the magnets adjacent in the direction in which the rotator is rotated becomes large, and it is known that the interval at which the magnets are arranged has a greater effect on the heating efficiency than the rotation number of the rotator. Thus, a relationship between the interval (the distance, the pitch) between the magnets and the magnetic flux density is examined as following.

### Implementation Example 6

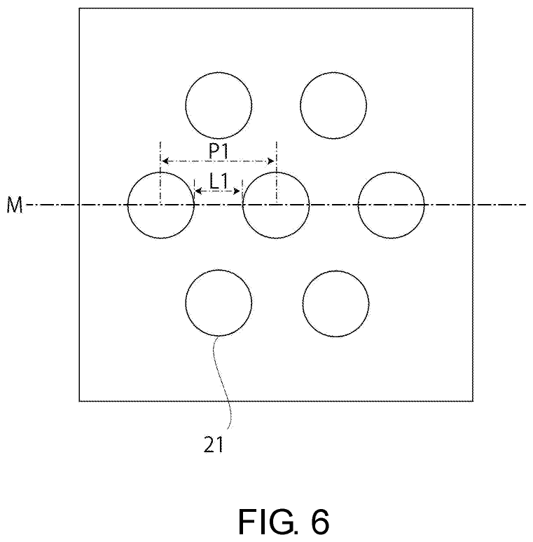

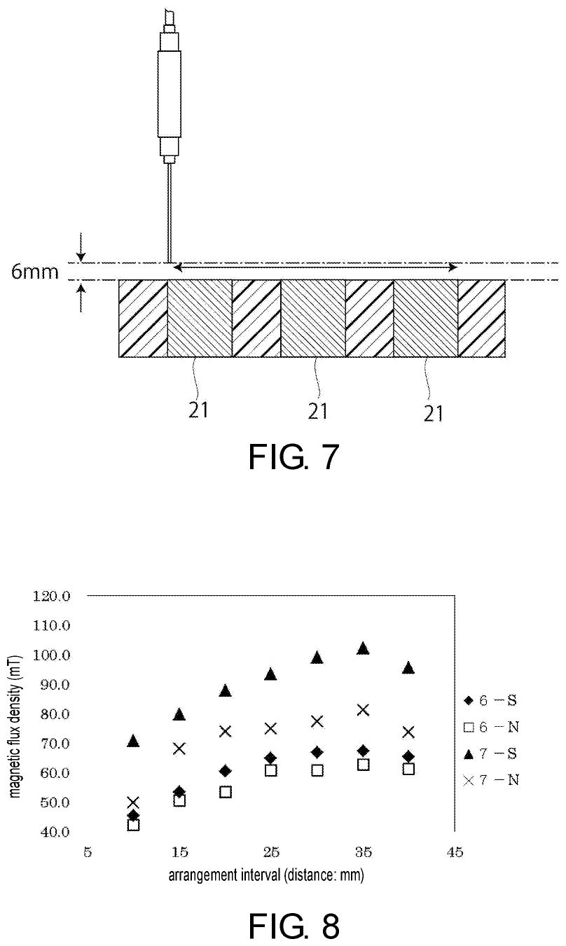

FIG. 6 and FIG. 7 are drawings schematically showing the arrangement of the magnets and a method for measuring the magnetic flux density in implementation examples 6 to 9.

As shown in FIG. 6, at corners and an intersection of diagonal lines of a regular hexagon, a total of seven magnets are arranged at equal intervals (distances L1, pitches P1) making the S poles face the side for measurement. Besides, as shown in FIG. 7, along a straight line M which connects the magnet arranged at the center of the hexagon and the magnets adjacent at both side of the above magnet, the magnetic flux density at a distance of 6 mm from the magnet surface is measured. The measurement results are shown in table 4.
Magnets: a cylinder with a diameter of 20 mm×a height of 10 mm, the magnetic flux density of the surface 457-478 mT (an average of 468 mT)
Interval: 10-40 mm (distance L1), 30-60 mm (pitch P1)

TABLE 4

| Arrangement interval (mm) | | Peak (mT) | | | | | |
|---|---|---|---|---|---|---|---|
| Pitch P1 | Distance L1 | S | N | S | N | S | N |
| 30 | 10 | 83.2 | 19.6 | 45.5 | 42.3 | 28.8 | 76.0 |
| 35 | 15 | 78.7 | 36.9 | 53.4 | 50.6 | 45.5 | 68.3 |
| 40 | 20 | 74.7 | 49.2 | 60.6 | 53.4 | 54.1 | 68.1 |
| 45 | 25 | 72.6 | 52.2 | 64.9 | 60.9 | 59.4 | 65.3 |
| 50 | 30 | 71.7 | 53.2 | 66.8 | 60.7 | 61.1 | 61.7 |
| 55 | 35 | 71.7 | 59.1 | 67.4 | 62.7 | 65.1 | 66.9 |
| 60 | 40 | 70.7 | 59.7 | 65.5 | 61.3 | 65.9 | 64.3 |

### Implementation Example 7

The following magnets are used to measure the magnetic flux density for the following magnets in the same way as implementation example 6. Results are shown in table 5.
Magnets: a cylindrical shape with a diameter of 20 mm×a height of 20 mm, the magnetic flux density of the surface 567-598 mT (an average of 577 mT)
Interval: 10-40 mm (distance L1), 30-60 mm (pitch P1)

TABLE 5

| Arrangement interval (mm) | | Peak (mT) | | | | | |
|---|---|---|---|---|---|---|---|
| Pitch P1 | Distance L1 | S | N | S | N | S | N |
| 30 | 10 | 125.3 | 14.9 | 70.7 | 49.9 | 33.8 | 113.9 |
| 35 | 15 | 118.4 | 42.4 | 79.7 | 68.0 | 62.2 | 109.8 |
| 40 | 20 | 115.2 | 59.8 | 87.7 | 73.9 | 71.0 | 102.6 |
| 45 | 25 | 108.3 | 62.7 | 93.5 | 74.8 | 79.4 | 88.8 |
| 50 | 30 | 110.3 | 66.9 | 99.0 | 77.3 | 89.5 | 82.3 |
| 55 | 35 | 110.0 | 74.5 | 102.2 | 81.2 | 97.9 | 88.2 |
| 60 | 40 | 103.8 | 66.2 | 95.5 | 73.6 | 86.4 | 73.8 |

For implementation example 6 and implementation example 7, maximum flux densities of S poles and N poles for each arrangement interval are summarized and shown in table 6 and FIG. 8.

TABLE 6

| | Maximum value of | |
|---|---|---|
| | magnetic flux density (mT) | |
| | Implementation | Implementation |
| Arrangement | example 6 | example 7 |
| interval (mm) | (20 × 10) | (20 × 20) |

| Pitch P1 | Interval L1 | S | N | S | N |
|---|---|---|---|---|---|
| 30 | 10 | 45.5 | 42.3 | 70.7 | 49.9 |
| 35 | 15 | 53.4 | 50.6 | 79.7 | 68.0 |
| 40 | 20 | 60.6 | 53.4 | 87.7 | 73.9 |
| 45 | 25 | 64.9 | 60.9 | 93.5 | 74.8 |
| 50 | 30 | 66.8 | 60.7 | 99.0 | 77.3 |
| 55 | 35 | 67.4 | 62.7 | 102.2 | 81.2 |
| 60 | 40 | 65.5 | 61.3 | 95.5 | 73.6 |

From the results shown in tables 4-6 and FIG. 8, it is known that when magnets having a magnetic flux density of about 450-600 mT are used, the magnetic flux density at the position which is 6 mm away from the magnet surface increases as the interval L1 increases until the interval L1 is about 30-35 mm and decreases when the interval L1 approximately exceeds 35 mm.

### Implementation Example 8

The following magnets are used to measure the magnetic flux density for the following magnets in the same way as implementation example 6. Results are shown in table 7.
Magnets: a cylinder with a diameter of 10 mm×a height of 5 mm, the magnetic flux density of the surface 411-440 mT (an average of 425 mT)
Interval: 27-45 mm (distance L1), 37-55 mm (pitch P1)

TABLE 7

| Arrangement interval (mm) | | Peak (mT) | | | | | |
|---|---|---|---|---|---|---|---|
| Pitch P1 | Distance L1 | S | N | S | N | S | N |
| 37 | 27 | 19.9 | 16.4 | 18.9 | 17.8 | 17.2 | 20.2 |
| 38 | 28 | 20.4 | 16.5 | 17.7 | 17.5 | 18.5 | 20.7 |
| 39 | 29 | 20.2 | 17.9 | 18.8 | 18.2 | 17.5 | 19.5 |
| 40 | 30 | 20.2 | 17.4 | 19.0 | 18.0 | 18.2 | 19.0 |
| 41 | 31 | 19.7 | 16.7 | 18.5 | 18.4 | 18.4 | 18.8 |
| 42 | 32 | 20.0 | 18.0 | 19.2 | 18.4 | 18.4 | 19.4 |
| 43 | 33 | 19.2 | 16.7 | 19.7 | 18.2 | 17.7 | 18.1 |
| 43.4 | 33.4 | 19.9 | 17.5 | 19.1 | 17.3 | 18.1 | 21.0 |
| 44 | 34 | 19.8 | 18.2 | 18.9 | 17.7 | 18.1 | 19.2 |
| 45 | 35 | 18.9 | 17.1 | 19.5 | 19.0 | 18.2 | 19.7 |
| 50 | 40 | 19.9 | 18.5 | 19.4 | 18.7 | 18.7 | 19.6 |
| 52.4 | 42.4 | 19.6 | 18.4 | 18.6 | 17.9 | 17.7 | 18.6 |
| 55 | 45 | 19.4 | 17.8 | 18.6 | 18.1 | 18.0 | 18.4 |

### Implementation Example 9

The following magnets are used to measure the magnetic flux density for the following magnets in the same way as implementation example 6. Results are shown in table 8.
Magnets: a cylinder with a diameter of 10 mm×a height of 10 mm, the magnetic flux density of the surface 507-531 mT (an average of 521 mT)
Interval: 27-45 mm (distance L1), 37-55 mm (pitch P1)

TABLE 8

| Arrangement interval (mm) | | Peak (mT) | | | | | |
|---|---|---|---|---|---|---|---|
| Pitch P1 | Distance L1 | S | N | S | N | S | N |
| 37 | 27 | 35.0 | 26.4 | 31.1 | 29.3 | 29.1 | 33.1 |
| 38 | 28 | 35.1 | 26.4 | 32.4 | 29.3 | 29.5 | 33.3 |
| 39 | 29 | 35.2 | 28.9 | 31.0 | 29.5 | 30.8 | 33.5 |
| 40 | 30 | 35.3 | 27.9 | 32.3 | 29.9 | 31.2 | 33.2 |
| 41 | 31 | 34.7 | 29.1 | 33.2 | 29.0 | 31.2 | 33.1 |
| 42 | 32 | 34.5 | 29.5 | 32.7 | 31.2 | 31.1 | 33.4 |
| 43 | 33 | 34.6 | 28.7 | 32.5 | 29.9 | 30.6 | 31.6 |
| 43.4 | 33.4 | 34.9 | 28.1 | 32.7 | 30.7 | 31.3 | 33.7 |
| 44 | 34 | 34.8 | 28.3 | 32.2 | 30.5 | 30.0 | 32.6 |
| 45 | 35 | 34.3 | 29.7 | 31.6 | 29.6 | 31.6 | 33.0 |
| 50 | 40 | 29.7 | 20.5 | 28.1 | 20.8 | 26.8 | 20.8 |
| 52.4 | 42.4 | 31.0 | 22.9 | 30.4 | 23.8 | 29.0 | 25.7 |
| 55 | 45 | 31.4 | 24.3 | 29.4 | 24.4 | 29.3 | 24.8 |

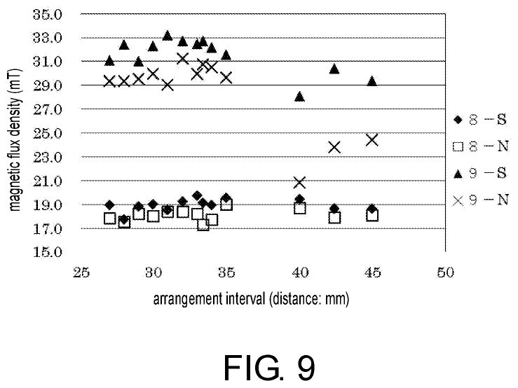

For implementation example 8 and implementation example 9, maximum flux densities of S poles and N poles for each arrangement interval are summarized and shown in table 9 and FIG. 9.

TABLE 9

| | Maximum value of | |
|---|---|---|
| | magnetic flux density (mT) | |
| | Implementation | Implementation |
| Arrangement | example 8 | example 9 |
| interval (mm) | (10 × 10) | (10 × 20) |

| Pitch P1 | Interval L1 | S | N | S | N |
|---|---|---|---|---|---|
| 37 | 27 | 18.9 | 17.8 | 31.1 | 29.3 |
| 38 | 28 | 17.7 | 17.5 | 32.4 | 29.3 |
| 39 | 29 | 18.8 | 18.2 | 31.0 | 29.5 |
| 40 | 30 | 19.0 | 18.0 | 32.3 | 29.9 |
| 41 | 31 | 18.5 | 18.4 | 33.2 | 29.0 |
| 42 | 32 | 19.2 | 18.4 | 32.7 | 31.2 |
| 43 | 33 | 19.7 | 18.2 | 32.5 | 29.9 |
| 43.4 | 33.4 | 19.1 | 17.3 | 32.7 | 30.7 |
| 44 | 34 | 18.9 | 17.7 | 32.2 | 30.5 |
| 45 | 35 | 19.5 | 19.0 | 31.6 | 29.6 |
| 50 | 40 | 19.4 | 18.7 | 28.1 | 20.8 |
| 52.4 | 42.4 | 18.6 | 17.9 | 30.4 | 23.8 |
| 55 | 45 | 18.6 | 18.1 | 29.4 | 24.4 |

From the results shown in tables 7-9 and FIG. 9, it is known that when magnets having a magnetic flux density of about 400-550 mT are used, the magnetic flux density at the position which is 6 mm away from the magnet surface is about the same when the interval L1 is in a range of about 25-35 mm and begins to decrease when the distance L1 exceeds about 35 mm.

From the results shown in FIG. 8 and FIG. 9, it can be stated that when magnets having a magnetic flux density of about 400-600 mT are used, from the viewpoint of improving the heating efficiency of the electromagnetic induction heating device, the interval between the magnets adjacent in the direction in which the rotator is rotated is preferably 20 mm or more and 50 mm or less, more preferably 25 mm or more and 45 mm or less, and further preferably 30 mm or more and 40 mm or less.

### INDUSTRIAL APPLICABILITY

The electromagnetic induction heating device of the present invention is useful as, for example, a device which heats dies or the like used during manufacturing of a semi-finished light alloy foil or aluminum sash to get a predetermined temperature suitable for a processing step in a short time.

### REFERENCE SIGNS LIST

1 electromagnetic induction heating device
2 rotator
21 magnet
22 rotation shaft
23 height adjustment part
3 rotation drive motor (rotation drive part)
4 distance measurement part
5 temperature measurement part
6 motor for movement
7 control part
8 object to be heated
X distance between magnet and object to be heated
L1 distance between magnets (interval between magnets)
P1 pitch (distance between centers of magnets)
O rotation center (center of concentric circle)
C, C1, C2, C3 concentric circle
R1, R2, R3 radius of concentric circle
D, D1, D2 difference between diameters of adjacent concentric circles (intervals between concentric circles)
ϕ diameter of magnet
H height of magnet

1. An electromagnetic induction heating device, comprising a rotator in which a plurality of magnets is arranged in a manner that the same poles are positioned on a side of an object to be heated, and a rotation drive part for rotating the rotator, and heating the object to be heated by an induction current which is generated by rotating the rotator by a rotation number at which the induction current is generated in the object to be heated with rotation, wherein
an interval between the magnets adjacent in a direction in which the rotator is rotated is 20 mm or more and 45 mm or less,
a distance from the object to be heated to the magnets of the rotator is 12 mm or less in the heating,
the object to be heated is made of a material which generates an eddy current by changing a magnetic field,
the plurality of magnets has
a cylindrical shape in which a diameter is 5 mm or more and 25 mm or less and a height is 10 mm or more and 40 mm or less,
a height of 0.5 time or more and 2 times or less of the diameter, and
a magnetic flux density of 400 mT or more and 600 mT or less, and
the plurality of magnets is mounted to the rotator via a height adjustment part for adjusting errors of height of the magnets to uniformize the heights of the magnets on the magnet surface.

2. (canceled)

3. The electromagnetic induction heating device according to claim 1, wherein
the plurality of magnets is arranged concentrically taking a rotation center of the rotator as a center.

4. The electromagnetic induction heating device according to claim 1, wherein
the plurality of magnets is arranged concentrically taking a rotation center of the rotator as a center,
the plurality of magnets arranged along each concentric circle is arranged at equal intervals.

5. The electromagnetic induction heating device according to claim 4, wherein.
the concentric circles are arranged at equal intervals, and
differences between diameters of the adjacent concentric circles are 40 mm or more and 60 mm or less.

6-9. (canceled)
